(19) United States
(12) Patent Application Publication
(10) Pub. No.: US 2023/0305162 A1
(43) Pub. Date: Sep. 28, 2023

(54) OBSTACLE SENSOR INSPECTION DEVICE AND METHOD

(71) Applicant: KABUSHIKI KAISHA TOYOTA JIDOSHOKKI, Kariya-shi (JP)

(72) Inventor: Kenya SUMIDA, Kariya-shi (JP)

(73) Assignee: KABUSHIKI KAISHA TOYOTA JIDOSHOKKI, Kariya-shi (JP)

(21) Appl. No.: 18/186,484

(22) Filed: Mar. 20, 2023

(30) Foreign Application Priority Data
Mar. 22, 2022 (JP) 2022-045110

(51) Int. Cl. G01S 17/931

(52) U.S. Cl. CPC G01S 17/931

(57) ABSTRACT

An obstacle sensor inspection device that performs an inspection of an obstacle sensor detecting an obstacle present in the vicinity of a mobile body, the obstacle sensor inspection device including; and a detection area setting unit configured to set a detection area of the obstacle sensor to a second area larger than a first area that is used at the time of normal running when the inspection process for the obstacle sensor is performed using the inspection processing unit, in which the inspection processing unit determines that the obstacle sensor is normal when the still object for inspection is detected by the obstacle sensor and determines that the obstacle sensor is abnormal when the still object for inspection is not detected by the obstacle sensor.

### CROSS REFERENCE TO RELATED APPLICATIONS

This application claims priority to Japanese Patent Application No. 2022-045110 filed on Mar. 22, 2022, the entire contents of which are incorporated by reference herein.

### TECHNICAL FIELD

The present disclosure relates to an obstacle sensor inspection device and a method.

### BACKGROUND

For example, in Japanese Unexamined Patent Publication No. 2015-222503, a technology in which, before an autonomous running operation vehicle performs autonomous running, it is checked whether or not there is an abnormality in sensors such as an obstacle sensor detecting presence/absence of an obstacle in the vicinity of the autonomous running operation vehicle and the like, and, when there is an abnormality in the sensors, abnormality details thereof are displayed on a display is described.

### SUMMARY

However, in the conventional technology described above, obstacle sensors are inspected only before an autonomous running operation vehicle performs autonomous running, and thus a breakdown at the time of running of the autonomous running operation vehicle cannot be handled.

An object of the present disclosure is to provide an obstacle sensor inspection device and a method capable of detecting whether or not an abnormality of an obstacle sensor has occurred during running of a mobile body.

According to one aspect of the present disclosure, there is provided an obstacle sensor inspection device that performs an inspection of an obstacle sensor detecting an obstacle present in the vicinity of a mobile body, the obstacle sensor inspection device including: a running control unit configured to perform control such that the mobile body is caused to run along a running path; an inspection processing unit configured to perform an inspection process for the obstacle sensor using a still object for inspection that is designated in advance in a sensor inspection section designated in advance in a state in which the mobile body is running along the running path; and a detection area setting unit configured to set a detection area of the obstacle sensor to a second area larger than a first area that is used at the time of normal running when the inspection process for the obstacle sensor is performed using the inspection processing unit, wherein the inspection processing unit determines that the obstacle sensor is normal when the still object for inspection is detected by the obstacle sensor and determines that the obstacle sensor is abnormal when the still object for inspection is not detected by the obstacle sensor.

In such an obstacle sensor inspection device, in a state in which the mobile body runs along a running path, when the mobile body reaches the sensor inspection section, an inspection process for the obstacle sensor is performed using the still object for inspection while the mobile body is running in the sensor inspection section. Then, when the still object for inspection is detected by the obstacle sensor, it is determined that the obstacle sensor is normal. On the other hand, when the still object for inspection is not detected by the obstacle sensor, it is determined that the obstacle sensor is abnormal. Here, as the detection area of the obstacle sensor, a second area wider than the first area that is used at the time of normal running is used. For this reason, when the mobile body runs in the sensor inspection section, the still object for inspection can be easily detected by the obstacle sensor. In accordance with this, it is detected whether an abnormality of the obstacle sensor has occurred during running of the mobile body.

The obstacle sensor inspection device may further include an inspection preparation processing unit configured to perform a preparation process for causing the mobile body not to come into contact with the obstacle when the mobile body runs in the sensor inspection section, in a sensor inspection preparation section positioned on a side in front of the sensor inspection section in a traveling direction of the mobile body before the inspection process for the obstacle sensor is performed by the inspection processing unit.

In such a configuration, when the mobile body reaches a sensor inspection preparation section positioned on a side in front of the sensor inspection section in the traveling direction of the mobile body, a preparation process for causing the mobile body not to come into contact with the obstacle at the time of the mobile body running in the sensor inspection section is performed while the mobile body runs in the sensor inspection preparation section. Thereafter, in the sensor inspection section, the inspection process for the obstacle sensor is performed. Thus, even in a case in which there is a likelihood of presence of an obstacle in the vicinity of the mobile body at the time of the mobile body running in the sensor inspection section, the mobile body is prevented from coming into contact with the obstacle.

The inspection preparation processing unit may set the detection area of the obstacle sensor to a third area larger than the first area and determine whether or not the obstacle is detected by the obstacle sensor in the state as the preparation process, and, in a case in which it is determined by the inspection preparation processing unit that the obstacle is not detected by the obstacle sensor, the inspection processing unit may determine that the obstacle sensor is normal when the still object for inspection is detected by the obstacle sensor and determine that the obstacle sensor is abnormal when the still object for inspection is not detected by the obstacle sensor.

In such a configuration, when the mobile body reaches the sensor inspection preparation section, in a state in which the detection area of the obstacle sensor has been changed from the first area to the third area, it is determined by the obstacle sensor whether an obstacle is detected. Then, when it is determined that no obstacle is detected by the obstacle sensor, an inspection process for the obstacle sensor is performed in the sensor inspection section. Here, as the detection area of the obstacle sensor, a third area wider than the first area that is used at the time of normal running is used. For this reason, when the mobile body runs in the sensor inspection preparation section, the obstacle can be easily detected by the obstacle sensor. Thus, when the mobile body runs in the sensor inspection section, it can be detected whether an obstacle is present in the vicinity of the mobile body with high accuracy.

The inspection preparation processing unit may perform control of the mobile body to be decelerated to a speed for not coming into contact with the obstacle at the time of the mobile body running in the sensor inspection section as the preparation process.

In such a configuration, when the mobile body reaches the sensor inspection preparation section, the mobile body is decelerated to a speed at which the mobile body will not come into contact with the obstacle when the mobile body runs in the sensor inspection section. In this way, by decelerating the mobile body in the sensor inspection preparation section, a distance required for an inspection of the obstacle sensor can be shortened.

The second area may be set to be wider than the first area in at least one of a traveling direction and a width direction of the mobile body.

In such a configuration, when the mobile body runs along the running path, a still object present in the traveling direction or on the lateral side of the mobile body is used as the still object for inspection.

The running path may include a curved part, the sensor inspection section may be designated to be at a position on a side in front of the curved part in a traveling direction of the mobile body, and the still object for inspection may be disposed at a position entering the inside of the second area when the mobile body runs in the sensor inspection section.

In such a configuration, a still object positioned in the vicinity of the curved part of the running path is used as a still object for inspection. Thus, by using an appropriate still object as the still object for inspection, an inspection process for the obstacle sensor can be effectively performed.

According to another aspect of the present disclosure, there is provided an obstacle sensor inspection method for performing an inspection of an obstacle sensor detecting an obstacle present in the vicinity of a mobile body, the obstacle sensor inspection method including: designating a sensor inspection section in which an inspection of the obstacle sensor is performed, a sensor inspection preparation section positioned on a side in front of the sensor inspection section in a traveling direction of the mobile body, and a still object for inspection used for an inspection of the obstacle sensor in the sensor inspection section, in the middle of a running path in which the mobile body runs; performing control such that the mobile body is caused to run along the running path; performing an inspection process for the obstacle sensor using the still object for inspection in a state in which the mobile body is running along the running path in the sensor inspection section; and setting a detection area of the obstacle sensor to a second area larger than a first area that is used at the time of normal running when the inspection process for the obstacle sensor is performed, wherein, in the performing of an inspection process for the obstacle sensor, it is determined that the obstacle sensor is normal when the still object for inspection is detected by the obstacle sensor, and it is determined that the obstacle sensor is abnormal when the still object for inspection is not detected by the obstacle sensor.

In such an obstacle sensor inspection method, in a state in which the mobile body runs along a running path, when the mobile body reaches the sensor inspection section, an inspection process for the obstacle sensor is performed using the still object for inspection while the mobile body is running in the sensor inspection section. Then, when the still object for inspection is detected by the obstacle sensor, it is determined that the obstacle sensor is normal. On the other hand, when the still object for inspection is not detected by the obstacle sensor, it is determined that the obstacle sensor is abnormal. Here, as the detection area of the obstacle sensor, a second area wider than the first area that is used at the time of normal running is used. For this reason, when the mobile body runs in the sensor inspection section, the still object for inspection can be easily detected by the obstacle sensor. In accordance with this, it is detected whether an abnormality of the obstacle sensor has occurred during running of the mobile body.

According to the present disclosure, it can be detected whether or not an abnormality of an obstacle sensor has occurred during running of a mobile body.

### BRIEF DESCRIPTION OF THE DRAWINGS

FIG. 1 is a schematic diagram illustrating a mobile body in which an obstacle sensor inspection device according to an embodiment of the present disclosure is mounted.

FIGS. 2A and 2B are diagrams illustrating an example of a sensor inspection section, a sensor inspection preparation section, and a detection area of a still object for inspection and an obstacle sensor that are designated in a running path.

FIG. 3 is a flowchart illustrating a part of the process of an obstacle sensor inspection method according to an embodiment of the present disclosure.

FIG. 4 is a flowchart illustrating another part of the process of the obstacle sensor inspection method according to an embodiment of the present disclosure.

FIG. 5 is a block diagram illustrating a configuration of a running control device including an obstacle sensor inspection device according to a first embodiment of the present disclosure.

FIG. 6 is a flowchart illustrating a procedure of a running control process performed by a running control unit illustrated in FIG. 5.

FIG. 7 is a flowchart illustrating a procedure of an inspection process performed by an inspection processing unit illustrated in FIG. 5.

FIG. 8 is a flowchart illustrating a procedure of a detection area setting process performed by a detection area setting unit illustrated in FIG. 5.

FIG. 9 is a flowchart illustrating a procedure of an inspection preparation process performed by an inspection preparation processing unit illustrated in FIG. 5.

FIGS. 10A and 10B are timing diagrams illustrating a running speed of a mobile body and a detection area of an obstacle sensor at the time of inspecting an obstacle sensor using an obstacle sensor inspection device illustrated in FIG. 5.

FIG. 11 is a block diagram illustrating a configuration of a running control device including an obstacle sensor inspection device according to a second embodiment of the present disclosure.

FIG. 12 is a flowchart illustrating a procedure of a detection area setting process performed by a detection area setting unit illustrated in FIG. 11.

FIG. 13 is a flowchart illustrating a procedure of an inspection preparation process performed by an inspection preparation processing unit illustrated in FIG. 11.

FIGS. 14A and 14B are timing diagrams illustrating a running speed of a mobile body and a detection area of an obstacle sensor at the time of inspecting an obstacle sensor using an obstacle sensor inspection device illustrated in FIG. 11.

FIG. 15 is a diagram illustrating a modified example of a detection area of an obstacle sensor in a sensor inspection section illustrated in FIGS. 2A and 2B.

### DETAILED DESCRIPTION

Hereinafter, embodiments of the present disclosure will be described in detail with reference to the drawings. In the drawings, the same reference signs will be assigned to that same or equivalent elements, and duplicate description will be omitted.

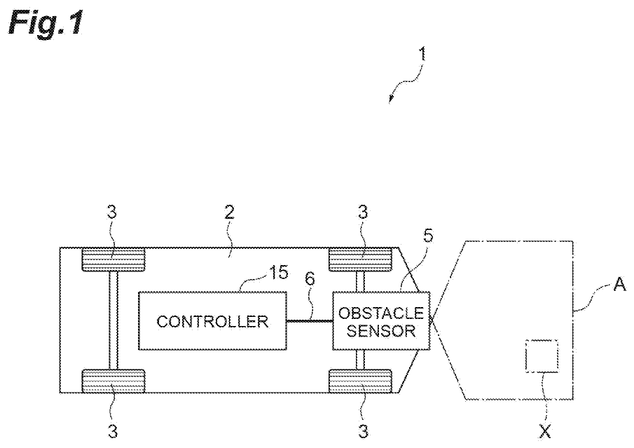

FIG. 1 is a schematic diagram illustrating a mobile body in which an obstacle sensor inspection device according to an embodiment of the present disclosure is mounted. In FIG. 1, the mobile body 1 is an industrial vehicle such as tractor or the like. The mobile body 1 includes a device base 2 and four vehicle wheels 3 disposed on front, rear, left, and right sides of this device base 2.

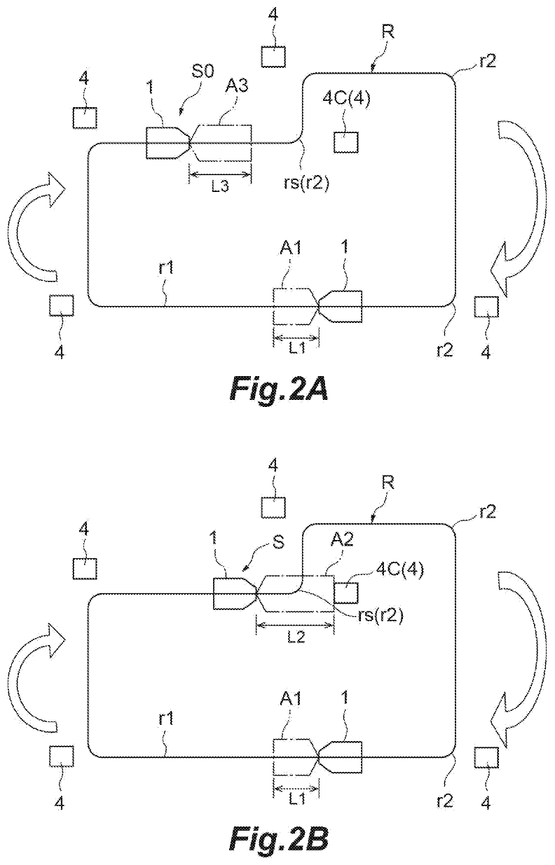

As illustrated in FIGS. 2A and 2B, the mobile body 1 performs autonomous running along a determined running path R. Here, the running path R is a circulation course. The running path R includes a linear part r1 and a curved part r2. In the vicinity of the running path R, a plurality of still objects 4 such as a column, a shelf, a wall, and the like are disposed.

The mobile body 1 includes an obstacle sensor 5 that detects obstacles X present in the vicinity of the mobile body 1 at the time of running along the running path R. The obstacles X are operators, other industrial vehicles, baggage, and the like. As the obstacle sensor 5, for example, a laser sensor such as a light detection and ranging (LIDAR) or a laser range finder is used. The laser sensor emits a laser beam to the vicinity of the mobile body 1 and receives reflected light of the laser beam, thereby detecting objects present in the vicinity of the mobile body 1. The laser sensor emits a laser beam to an area including that in a running direction of (forward from) the mobile body 1.

The obstacle sensor 5 is a sensor of an area setting type in which a detection area A is set and detects whether or not an obstacle X is present in the detection area A. Although not particularly illustrated, the detection area A of the obstacle sensor 5 includes a stop area and a deceleration area. The deceleration area is a range wider than the stop area.

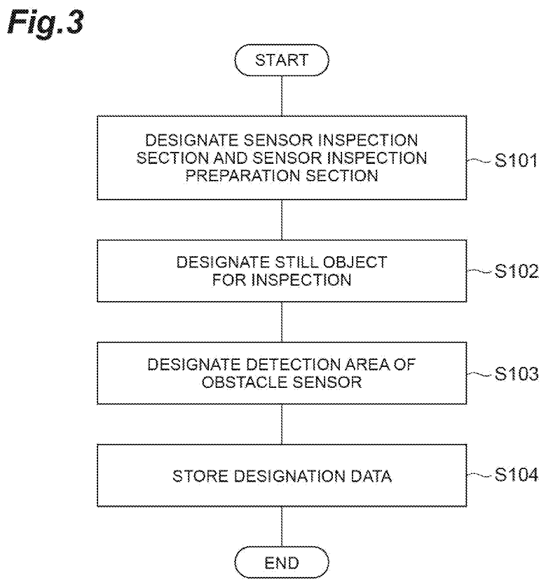

In this embodiment, when the mobile body 1 is running along a running path R, an inspection of an obstacle sensor 5 is performed. As illustrated in FIGS. 2A and 3B, in the middle of the running path R, a sensor inspection section S (see FIG. 2B), a sensor inspection preparation section S0 (see FIG. 2A), and a still object for inspection 4C are designated.

The sensor inspection section S is a section in which an inspection of the obstacle sensor 5 is performed during running of the mobile body 1. The sensor inspection section S is designated as a position in front of one curved part r2 (denoted as a curved part rs) among a plurality of curved parts r2 of the running path R in a traveling direction of the mobile body 1. A length of the sensor inspection section S is a distance required for the mobile body 1 to run for a time required for inspection of the obstacle sensor 5 or more.

The sensor inspection preparation section S0 is positioned on a side in front of the sensor inspection section S in the traveling direction of the mobile body 1. The sensor inspection preparation section S0 is a section in which preparation for causing the mobile body 1 not to come into contact with the obstacle X when the mobile body 1 is running in the sensor inspection section S is performed. A distance of the sensor inspection preparation section S0 is a distance to run for a time required for preparation for causing the mobile body 1 not to come into contact with the obstacle X when the mobile body 1 is running in the sensor inspection section S or more.

The still object for inspection 4C is disposed in the vicinity of a curved part rs of the running path R. More specifically, when the mobile body 1 runs in a linear part r1 in front of the curved part rs, the still object for inspection 4C is disposed on a side in front of the mobile body 1. The still object for inspection 4C is a still object 4 that is used for an inspection of the obstacle sensor 5.

FIG. 3 is a flowchart illustrating a part of the process of an obstacle sensor inspection method according to an embodiment of the present disclosure. This flowchart illustrates a process of a prior stage performed by a user before an inspection of the obstacle sensor 5 is actually performed.

In FIG. 3, first, in a running path R, the sensor inspection section S and the sensor inspection preparation section S0 described above are designated (procedure S101). In addition, the still object for inspection 4C described above is designated (procedure S102).

In addition, a detection area A of the obstacle sensor 5 is designated (procedure S103). As the detection area A of the obstacle sensor 5, a first area A1 used at the time of normal running of the mobile body 1, a second area A2 used when the mobile body 1 is running in the sensor inspection section S, and a third area A3 used when the mobile body 1 is running in the sensor inspection preparation section S0 are designated. The detection area A of the obstacle sensor 5 will be described next in detail.

Then, designation data of the sensor inspection section S, the sensor inspection preparation section S0, the still object for inspection 4C, and the detection area A of the obstacle sensor 5 is stored in a storage unit 11 to be described below (procedure S104).

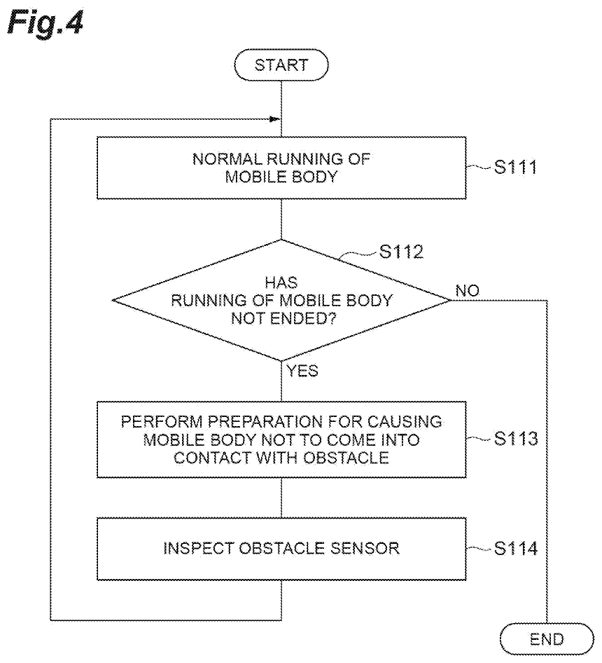

FIG. 4 is a flowchart illustrating another part of the process of the obstacle sensor inspection method according to the embodiment of the present disclosure. This flowchart illustrates a process in which an inspection of the obstacle sensor 5 is actually performed. For example, this flowchart is performed when an instruction for start of an inspection of the obstacle sensor 5 is received in accordance with an operation switch (not illustrated).

In FIG. 4, first, the mobile body 1 is caused to perform normal running at a regulated speed V along a running path R (procedure S111). Subsequently, it is determined whether running of the mobile body 1 has ended (procedure S112). When the running of the mobile body 1 has ended, this flowchart ends.

When the running of the mobile body 1 has not ended, in a sensor inspection preparation section S0, while the mobile body 1 is running, preparation for causing the mobile body 1 not to come into contact with an obstacle X at the time of the mobile body 1 running in the sensor inspection section S is performed (procedure S113). Subsequently, in a sensor inspection section S, an inspection of the obstacle sensor 5 is performed while the mobile body 1 is running (procedure S114). Then, the process S111 described above is performed again.

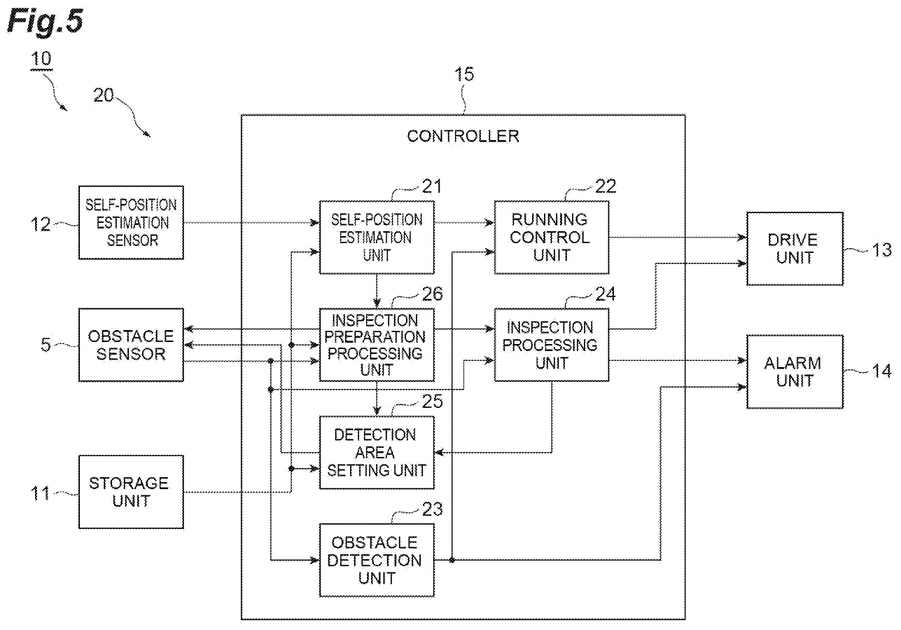

FIG. 5 is a block diagram illustrating a configuration of a running control device including an obstacle sensor inspection device according to a first embodiment of the present disclosure. The running control device 10 is a device that causes a mobile body 1 to autonomously run along a running path R. The running control device 10 is mounted in the mobile body 1.

The running control device 10 includes the obstacle sensor 5 described above, a storage unit 11, a self-position estimation sensor 12, a drive unit 13, an alarm unit 14, and a controller 15.

The storage unit 11 stores map data of an area in which the mobile body 1 runs, running path data in which the mobile body 1 runs, designation data of the sensor inspection section S, the sensor inspection preparation section S0, the still object for inspection 4C, and the detection area A of the obstacle sensor 5 described above, and the like.

The self-position estimation sensor 12 is used for estimating a self-position of the mobile body 1. The self-position estimation sensor 12 detects still objects 4 present in the vicinity of the mobile body 1 at the time of running of the mobile body 1. Here, as the self-position estimation sensor 12, similar to the obstacle sensor 5, a laser sensor, or the like is used.

For example, although not illustrated, the drive unit 13 includes a running motor that rotates vehicle wheels 3 of the mobile body 1 and a steering motor that steers the vehicle wheels 3.

When an obstacle X present in the vicinity of the mobile body 1 is detected by the obstacle sensor 5, the alarm unit 14 gives an alarm indicating that the obstacle X is present. The alarm unit 14 gives an alarm using an alarm sound or an alarm display.

The controller 15 is composed of a CPU, a RAM, a ROM, and input/output interface, and the like. The controller 15 includes a self-position estimation unit 21, a running control unit 22, an obstacle detection unit 23, an inspection processing unit 24, a detection area setting unit 25, and an inspection preparation processing unit 26. Functions thereof are performed, for example, when start of autonomous running of the mobile body 1 is instructed from an operation switch (not illustrated).

The self-position estimation unit 21 estimates a self-position of the mobile body 1 on the basis of detection data acquired by the self-position estimation sensor 12 and map data stored in the storage unit 11. More specifically, the self-position estimation unit 21 estimates a self-position of the mobile body 1, for example, by matching the detection data acquired by the self-position estimation sensor 12 and the map data using a simultaneous localization and mapping (SLAM) technique. The SLAM is a self-position estimation technology for performing self-position estimation using sensor data and map data.

The running control unit 22 performs control of the drive unit 13 such that the mobile body 1 is caused to run along a running path R on the basis of the self-position of the mobile body 1 estimated by the self-position estimation unit 21. The procedure of the running control unit 22 will be described below.

The obstacle detection unit 23 determines whether or not an obstacle is present in a traveling direction of (forward from) the mobile body 1 on the basis of detection data acquired by the obstacle sensor 5 and outputs an alarm notification signal to the alarm unit 14 and the running control unit 22 in a case in which an obstacle is present in the traveling direction of the mobile body 1.

In a state in which the mobile body 1 is running along a running path R, the inspection processing unit 24 performs a process of inspecting an obstacle sensor 5 using a still object for inspection 4C in the sensor inspection section S. When the still object for inspection 4C is detected by the obstacle sensor 5, the inspection processing unit 24 determines that the obstacle sensor 5 is normal. On the other hand, when no still object for inspection 4C is not detected by the obstacle sensor 5, the inspection processing unit 24 determines that the obstacle sensor 5 is abnormal. The procedure of the inspection processing unit 24 will be described below.

When an inspection process for the obstacle sensor 5 is performed in the sensor inspection section S by the inspection processing unit 24, the detection area setting unit 25 sets the detection area A of the obstacle sensor 5 to the second area A2 that is wider than the first area A1 used at the time of normal running.

As illustrated in FIG. 2B, the second area A2 is wider than the first area A1 in the traveling direction of the mobile body 1. In other words, a length dimension L2 of the second area A2 is larger than a length dimension L1 of the first area A1. The length dimension of the detection area A of the obstacle sensor 5 is a dimension in the traveling direction of the mobile body 1. The still object for inspection 4C described above is disposed at a position entering the inside of the second area A2 when the mobile body 1 runs in the sensor inspection section S.

Before performing the inspection process for the obstacle sensor using the inspection processing unit 24, the inspection preparation processing unit 26 performs a preparation process, which causes the mobile body 1 not to come into contact with the obstacle X when the mobile body 1 runs in the sensor inspection section S, in the sensor inspection preparation section S0. As the preparation process, the inspection preparation processing unit 26 sets the detection area A of the obstacle sensor 5 to the third area A3 that is wider than the first area A1 and determines whether the obstacle X is to be detected by the obstacle sensor 5 in the state.

As illustrated in FIGS. 2A and 2B, the third area A3 is wider than the first area A1 in the traveling direction of the mobile body 1 and is narrower than the second area A2 in the traveling direction of the mobile body 1. For example, the third area A3 is wider than the first area A1 in the traveling direction of the mobile body 1 by an amount corresponding to a distance x to run in a time required for the mobile body 1 to inspect the obstacle sensor 5. In other words, a length dimension L3 of the third area A3 is an added value (L1+x) acquired by adding a length dimension L1 of the first area A1 and the distance x. The procedure of the inspection preparation processing unit 26 will be described below.

The obstacle sensor inspection device 20 according to this embodiment is a device that inspects the obstacle sensor 5. In other words, the obstacle sensor inspection device 20 is a device that performs the obstacle sensor inspection method described above. The obstacle sensor inspection device 20 is composed of a storage unit 11, a self-position estimation sensor 12, a drive unit 13, an alarm unit 14, and the self-position estimation unit 21, the running control unit 22, the inspection processing unit 24, the detection area setting unit 25, and the inspection preparation processing unit 26 of the controller 15.

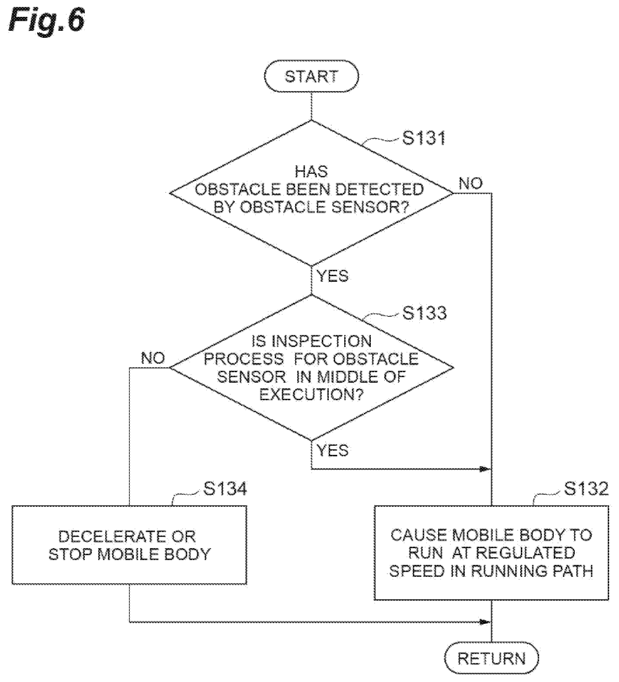

FIG. 6 is a flowchart illustrating a procedure of a running control process performed by the running control unit 22. In FIG. 6, the running control unit 22, first, determines whether an obstacle X present in the traveling direction of the mobile body 1 has been detected by the obstacle sensor 5 by determining whether an alarm notification signal has been input from the obstacle detection unit 23 (procedure S131).

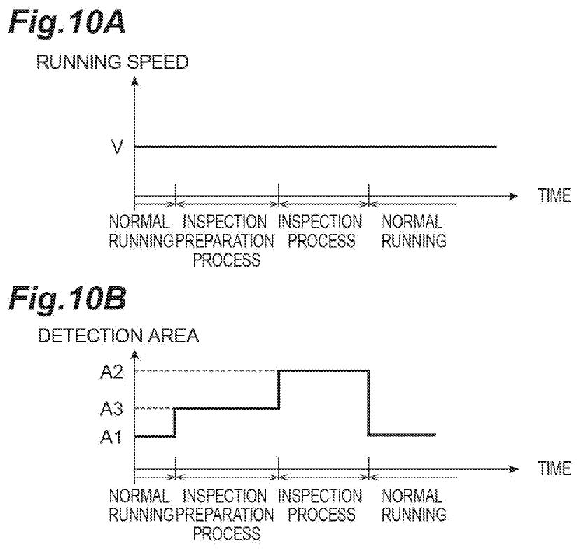

When it is determined that an obstacle X present in the traveling direction of the mobile body 1 has not been detected by the obstacle sensor 5, the running control unit 22 performs the procedure S131 described above again by performing control of the drive unit 13 (procedure S132) such that the mobile body 1 is caused to run at a regulated speed V (see FIG. 10A) along a running path R on the basis of the self-position of the mobile body 1 that is estimated by the self-position estimation unit 21.

When it is determined that an obstacle X present in the traveling direction of the mobile body 1 has been detected by the obstacle sensor 5, the running control unit 22 determines whether an inspection start signal (to be described below) has been input from the inspection preparation processing unit 26, thereby determining whether the process of inspecting the obstacle sensor 5 using the inspection processing unit 24 is being performed (procedure S133).

When it is determined that the process of inspecting the obstacle sensor 5 using the inspection processing unit 24 is not being performed, the running control unit 22 performs the procedure S131 described above again by performing control of the drive unit 13 to stop or decelerate the mobile body 1 (procedure S134). At this time, when presence of an obstacle X inside the stop area (described above) of the detection area A of the obstacle sensor 5 is detected by the obstacle detection unit 23, the drive unit 13 is controlled to stop the mobile body 1. When it is detected by the obstacle detection unit 23 that an obstacle X is absent inside the stop area of the detection area A of the obstacle sensor 5, and an obstacle X is present inside the deceleration area (described above), the drive unit 13 is controlled to decelerate the mobile body 1.

When it is determined that the process of inspecting the obstacle sensor 5 using the inspection processing unit 24 is being performed, the running control unit 22 performs control of the drive unit 13 to cause the mobile body 1 to run at a regulated speed V along a running path R (procedure S132). In accordance with this, when the process of inspecting the obstacle sensor 5 is performed, even in a case in which an obstacle X present in the traveling direction of the mobile body 1 is detected by the obstacle sensor 5, an operation of stopping or decelerating the mobile body 1 is invalidated.

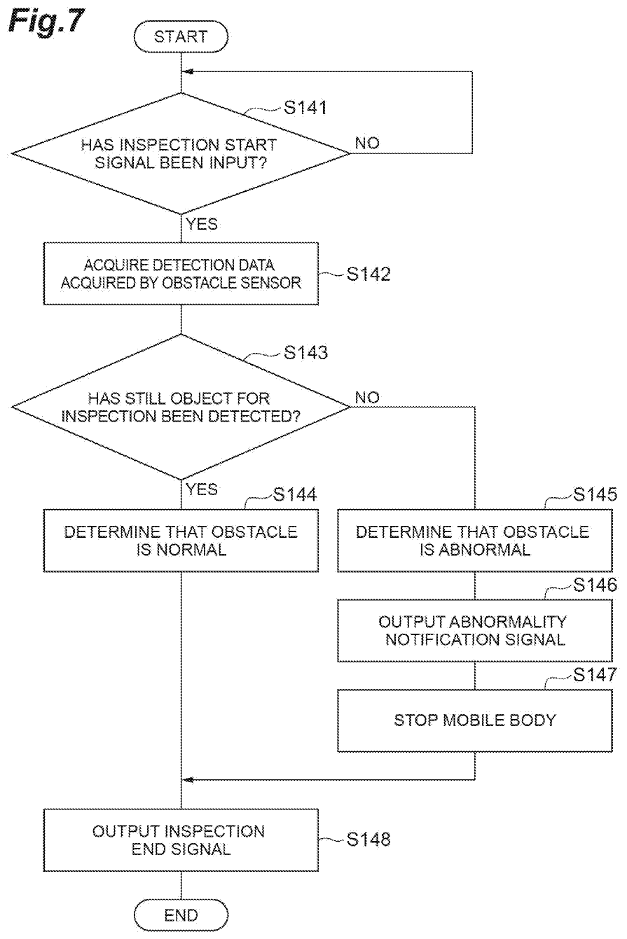

FIG. 7 is a flowchart illustrating a procedure of an inspection process performed by the inspection processing unit 24. In FIG. 7, the inspection processing unit 24, first, determines whether an inspection start signal (to be described below) has been input from the inspection preparation processing unit 26 (procedure S141).

When it is determined that the inspection start signal has been input, the inspection processing unit 24 acquires detection data acquired by the obstacle sensor 5 (procedure S142). Then, the inspection processing unit 24 determines whether a still object for inspection 4C has been detected on the basis of the detection data acquired by the obstacle sensor 5 (procedure S143). When it is determined that the still object for inspection 4C has been detected, the inspection processing unit 24 determines that the obstacle sensor 5 is normal (procedure S144).

When it is determined that the still object for inspection 4C has not been detected, the inspection processing unit 24 determines that the obstacle sensor 5 is abnormal (procedure S145). Then, the inspection processing unit 24 outputs an abnormality notification signal used for performing an abnormality alarm using the alarm unit 14 to the alarm unit 14 (procedure S146). In addition, the inspection processing unit 24 performs control of the drive unit 13 to stop the mobile body 1 (procedure S147).

After the procedure S144 or the procedure S147 is performed, the inspection processing unit 24 outputs an inspection end signal used for notifying that an inspection operation using the inspection processing unit 24 for the obstacle sensor 5 has ended to the detection area setting unit 25 (procedure S148) and ends this process.

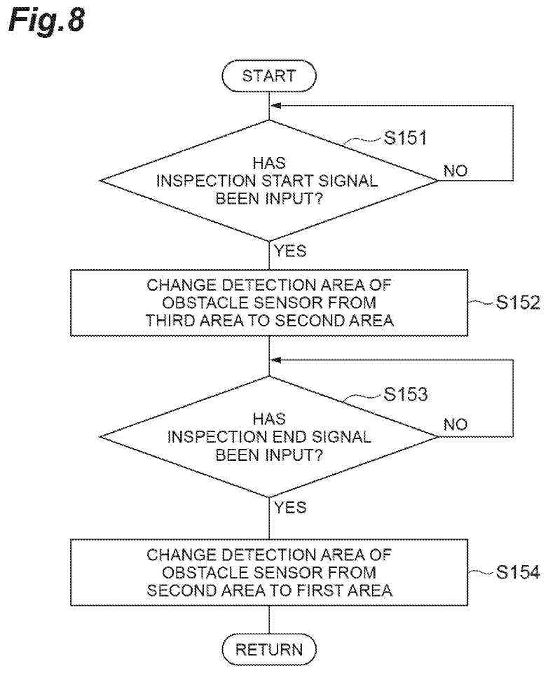

FIG. 8 is a flowchart illustrating a procedure of a detection area setting process performed by the detection area setting unit 25. In FIG. 8, the detection area setting unit 25, first, determines whether an inspection start signal (to be described later) has been input from the inspection preparation processing unit 26 (procedure S151).

When it is determined that the inspection start signal has been input, the detection area setting unit 25 changes the detection area A of the obstacle sensor 5 from the third area A3 to the second area A2 (procedure S152). Subsequently, the detection area setting unit 25 determines whether the inspection end signal has been input from the inspection processing unit 24 (procedure S153).

When it is determined that the inspection end signal has been input, the detection area setting unit 25 changes the detection area of the obstacle sensor 5 from the second area A2 to the first area A1 (procedure S154) and performs the procedure S151 described above again.

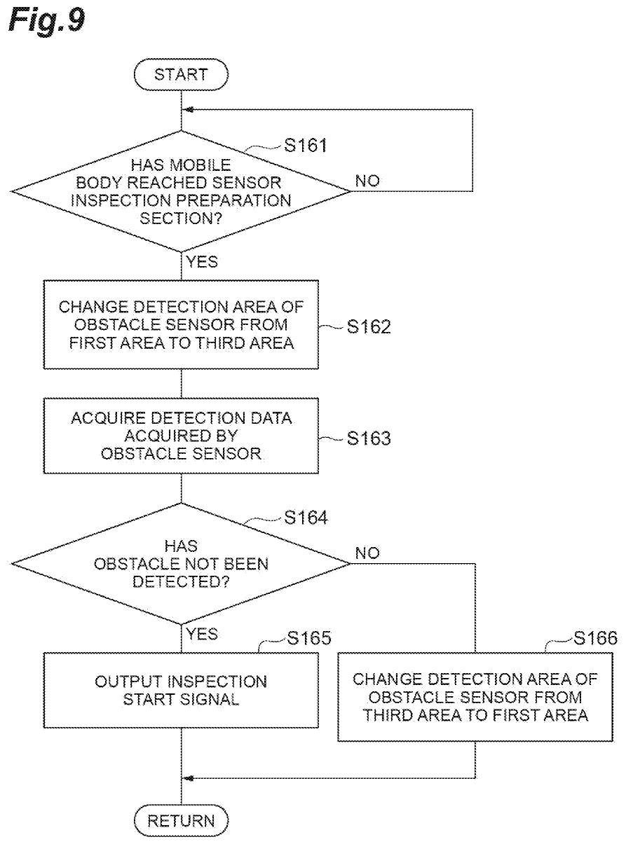

FIG. 9 is a flowchart illustrating a procedure of the inspection preparation process performed by the inspection preparation processing unit 26. In FIG. 9, the inspection preparation processing unit 26, first, determines whether the mobile body 1 has reached the sensor inspection preparation section S0 on the basis of a self-position of the mobile body 1 that is estimated by the self-position estimation unit 21 (procedure S161).

When it is determined that the mobile body 1 has reached the sensor inspection preparation section S0, the inspection preparation processing unit 26 changes the detection area A of the obstacle sensor 5 from the first area A1 to the third area A3 (procedure S162).

Subsequently, the inspection preparation processing unit 26 acquires detection data acquired by the obstacle sensor 5 (procedure S163). Then, the inspection preparation processing unit 26 determines whether or not an obstacle X present in the traveling direction of the mobile body 1 has not been detected on the basis of the detection data acquired by the obstacle sensor 5 (procedure S164).

When it is determined that an obstacle X present in the traveling direction of the mobile body 1 has not been detected, the inspection preparation processing unit 26 outputs an inspection start signal used for giving an instruction for starting an inspection operation for the obstacle sensor 5 using the inspection processing unit 24 to the running control unit 22, the inspection processing unit 24, and the detection area setting unit 25 (procedure S165) and performs the procedure S161 described above again.

On the other hand, when it is determined that an obstacle X present in the traveling direction of the mobile body 1 has been detected, the inspection preparation processing unit 26 changes the detection area A of the obstacle sensor 5 from the third area A3 to the first area A1 (procedure S166) and performs the procedure S161 described above again.

As above, when start of autonomous running of the mobile body 1 is instructed, the mobile body 1 performs normal running at a regulated speed V along a running path R. At the time of normal running of the mobile body 1, the first area A1 is used as the detection area A of the obstacle sensor 5. When an obstacle X is detected in front of the mobile body 1 by the obstacle sensor 5 during running of the mobile body 1, the mobile body 1 stops or decelerates.

When the mobile body 1 reaches the sensor inspection preparation section S0 in a state in which presence of an obstacle X in front of the mobile body 1 has not been detected by the obstacle sensor 5, as illustrated in FIGS. 10A and 10B, the detection area A of the obstacle sensor 5 is set to the third area A3 that is wider than the first area A1, and the mobile body 1 runs at the same speed V for a time required for an inspection of the obstacle sensor 5.

When the mobile body 1 runs for a time required for an inspection of the obstacle sensor 5, in a case in which an obstacle X is detected in front of the mobile body 1 by the obstacle sensor 5, the detection area A of the obstacle sensor 5 returns from the third area A3 to the first area A1, and the mobile body 1 returns to the normal running state. For this reason, in accordance with presence of an obstacle X in front of the mobile body 1, the mobile body 1 stops or decelerates. In addition, for example, in a case in which an obstacle X is detected any number of times every time the mobile body 1 passes through the sensor inspection preparation section S0, the sensor inspection preparation section S0 is inappropriate, and thus, by giving a warning using the alarm unit 14, a user is promoted to review the sensor inspection preparation section S0.

When an obstacle X is not detected in front of the mobile body 1 by the obstacle sensor 5 even in a case in which the mobile body 1 runs for a time required for inspecting the obstacle sensor 5, in accordance with the mobile body 1 reaching the sensor inspection section S, as illustrated in FIGS. 10A and 10B, the detection area A of the obstacle sensor 5 is set to the second area A2 that is wider than the third area A3, and the mobile body 1 runs at the same speed V. Then, in the state in which the mobile body 1 runs as it is, an inspection of the obstacle sensor is performed. At this time, since an operation of stopping or decelerating the mobile body 1 in accordance with a detection result acquired by the obstacle sensor 5 is invalidated, an inspection of the obstacle sensor 5 using the still object for inspection 4C is not inhibited.

When the still object for inspection 4C is detected by the obstacle sensor 5, it is determined that the obstacle sensor 5 is normal. Then, the detection area A of the obstacle sensor 5 is changed from the second area A2 to the first area A1, and the mobile body 1 returns to the normal running state.

On the other hand, when the still object for inspection 4C is not detected by the obstacle sensor 5, it is determined that the obstacle sensor is abnormal. Then, together with giving a warning using the alarm unit 14, the mobile body 1 is forced to stop. In this case, until the obstacle sensor 5 is recovered in accordance with repairs or the like or replacement of the obstacle sensor 5 is completed, autonomous running of the mobile body 1 is not performed.

As described above, in this embodiment, in a state in which the mobile body 1 is running along a running path R, when the mobile body 1 reaches the sensor inspection section S, the process of inspecting the obstacle sensor 5 is performed using the still object for inspection 4C while the mobile body 1 is running through the sensor inspection section S. Then, when the still object for inspection 4C is detected by the obstacle sensor 5, it is determined that the obstacle sensor 5 is normal. On the other hand, when the still object for inspection 4C is not detected by the obstacle sensor 5, it is determined that the obstacle sensor 5 is abnormal. Here, as the detection area A of the obstacle sensor 5, the second area A2 that is wider than the first area A1 used at the time of normal running is used. For this reason, when the mobile body 1 runs in the sensor inspection section S, the still object for inspection 4C can be easily detected by the obstacle sensor 5. In accordance with this, whether an abnormality of the obstacle sensor 5 has occurred is detected during running of the mobile body 1. As a result, a breakdown of the mobile body 1 at the time of running can be handled.

In addition, in this embodiment, when the mobile body 1 reaches the sensor inspection preparation section S0 positioned on a side in front of the sensor inspection section S in the traveling direction of the mobile body 1, a preparation process, which causes the mobile body 1 not to come into contact with the obstacle X at the time of the mobile body 1 running in the sensor inspection section S, is performed while the mobile body 1 is running in the sensor inspection preparation section S0. Thereafter, in the sensor inspection section S, an inspection process for the obstacle sensor 5 is performed. Thus, even in a case in which there is a likelihood of an obstacle X being present in the vicinity of the mobile body 1 when the mobile body 1 runs in the sensor inspection section S, the mobile body 1 is prevented from coming into contact with the obstacle X.

In addition, in this embodiment, when the mobile body 1 reaches the sensor inspection preparation section S0, in a state in which the detection area A of the obstacle sensor 5 is changed from the first area A1 to the third area A3, it is determined whether an obstacle X is detected by the obstacle sensor 5. Then, when it is determined that an obstacle X is not detected by the obstacle sensor 5, an inspection process for the obstacle sensor 5 is performed in the sensor inspection section S. Here, as the detection area A of the obstacle sensor 5, the third area A3 that is wider than the first area A1 used at the time of normal running is used. For this reason, when the mobile body 1 runs in the sensor inspection preparation section S0, it becomes easy to detect an obstacle X using the obstacle sensor 5. Thus, when the mobile body 1 runs in the sensor inspection section S, it can be detected whether an obstacle X is present in the vicinity of the mobile body 1 with high accuracy.

In addition, in this embodiment, the second area A2 is set to be wider than the first area A1 in the traveling direction of the mobile body 1. For this reason, when the mobile body 1 runs in the running path R, a still object 4 present in the traveling direction of the mobile body 1 is used as the still object for inspection 4C.

Furthermore, in this embodiment, the sensor inspection section S is designated to be at a position on a side in front of the curved part rs of the running path R in the traveling direction of the mobile body 1, and the still object for inspection 4C is disposed at a position entering the inside of the second area A2 as the detection area A of the obstacle sensor 5 when the mobile body 1 runs in the sensor inspection section S. For this reason, a still object 4 positioned near the curved part rs of the running path R is used as the still object for inspection 4C. Thus, by using an appropriate still object 4 as the still object for inspection 4C, an inspection process for the obstacle sensor 5 can be effectively performed.

In addition, in this embodiment, not only abnormalities of the sensor main body of the obstacle sensor 5 but also disconnection and formation of a short circuit of the cable 6 (see FIG. 1) connecting the obstacle sensor 5 and the controller 15 and dirt and the like attached to a sensor face of the obstacle sensor 5 according to an external environment can be detected as abnormalities of the obstacle sensor 5.

Furthermore, in this embodiment, the still object for inspection 4C is used for an inspection of the obstacle sensor 5, and thus, an operator may not be intervened in the inspection of the obstacle sensor 5, and a burden of the operator can be alleviated.

In addition, in this embodiment, although the third area A3 is wider than the first area A1 in the traveling direction of the mobile body 1 and is narrower than the second area A2 in the traveling direction of the mobile body 1, the present disclosure is not particularly limited to such a form, and the third area A3 and the second area A2 may be configured to be the same.

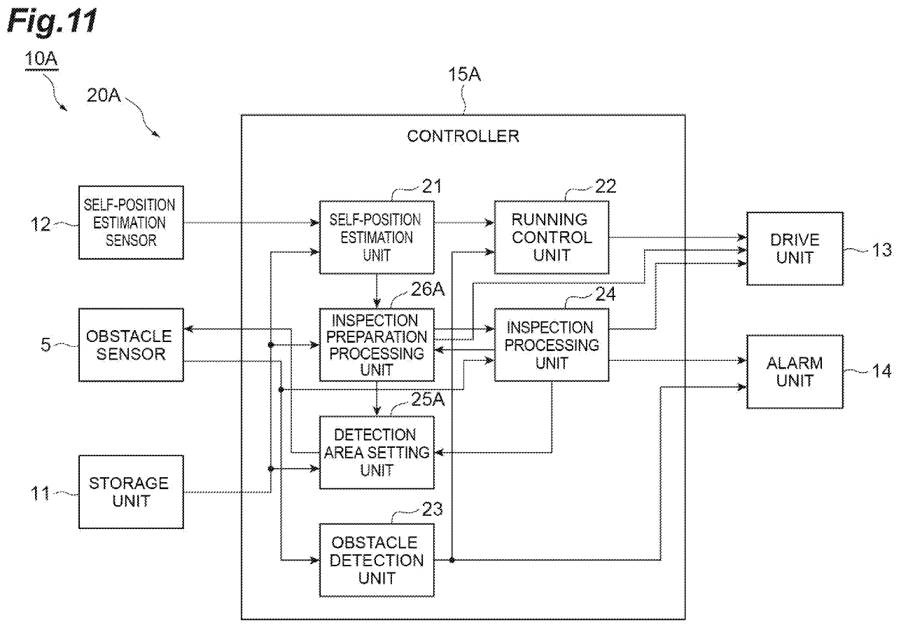

FIG. 11 is a block diagram illustrating a configuration of a running control device including an obstacle sensor inspection device according to a second embodiment of the present disclosure.

In FIG. 11, the running control device 10A includes a controller 15A in place of the controller 15 according to the first embodiment. The controller 15A includes the self-position estimation unit 21, the running control unit 22, the obstacle detection unit 23, and the inspection processing unit 24 described above and a detection area setting unit 25A and an inspection preparation processing unit 26A.

When an inspection process for an obstacle sensor 5 is performed by the inspection processing unit 24, the detection area setting unit 25A sets a detection area A of the obstacle sensor 5 to a second area A2 that is wider than the first area A1 used at the time of normal running.

Before performing the inspection process for the obstacle sensor using the inspection processing unit 24, the inspection preparation processing unit 26A performs a preparation process, which causes the mobile body 1 not to come into contact with the obstacle X when the mobile body 1 runs in the sensor inspection section S, in the sensor inspection preparation section S0. The inspection preparation processing unit 26A performs control of the drive unit 13 such that the mobile body 1 is decelerated to a speed causing the mobile body 1 not to come into contact with the obstacle X at the time of the mobile body 1 running in the sensor inspection section S as a preparation process.

The obstacle sensor inspection device 20A according to this embodiment is composed of a storage unit 11, a self-position estimation sensor 12, a drive unit 13, an alarm unit 14, and the self-position estimation unit 21, the running control unit 22, the inspection processing unit 24, the detection area setting unit 25A, and the inspection preparation processing unit 26A of the controller 15.

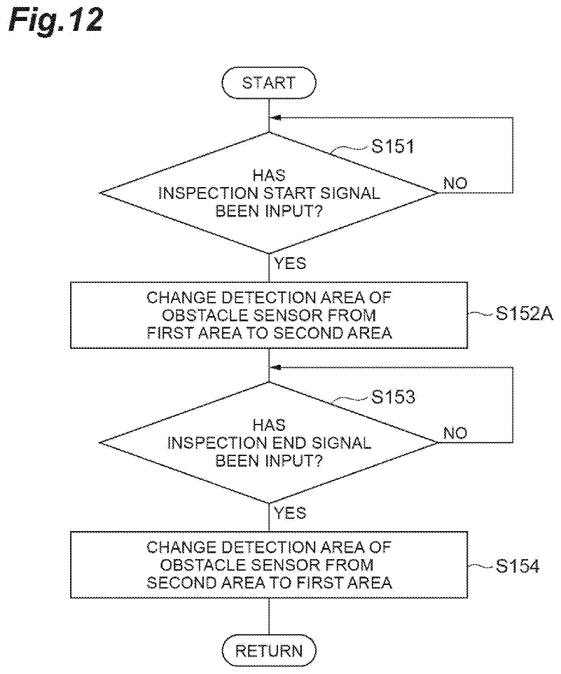

FIG. 12 is a flowchart illustrating a procedure of a detection area setting process performed by the detection area setting unit 25A and corresponds to FIG. 8. In FIG. 12, the detection area setting unit 25A, first, determines whether an inspection start signal (described above) has been input from the inspection preparation processing unit 26A (procedure S151).

When it is determined that the inspection start signal has been input, the detection area setting unit 25A changes the detection area A of the obstacle sensor 5 from a first area A1 to a second area A2 (procedure S152A). Subsequently, the detection area setting unit 25A determines whether an inspection end signal (described above) has been input from the inspection processing unit 24 (procedure S153). When it is determined that the inspection end signal has been input, the detection area setting unit 25A changes the detection area A of the obstacle sensor from the second area A2 to the first area A1 (procedure S154).

In addition, in this embodiment, the inspection end signal from the inspection processing unit 24 is input not only to the detection area setting unit 25A also to the inspection preparation processing unit 26A.

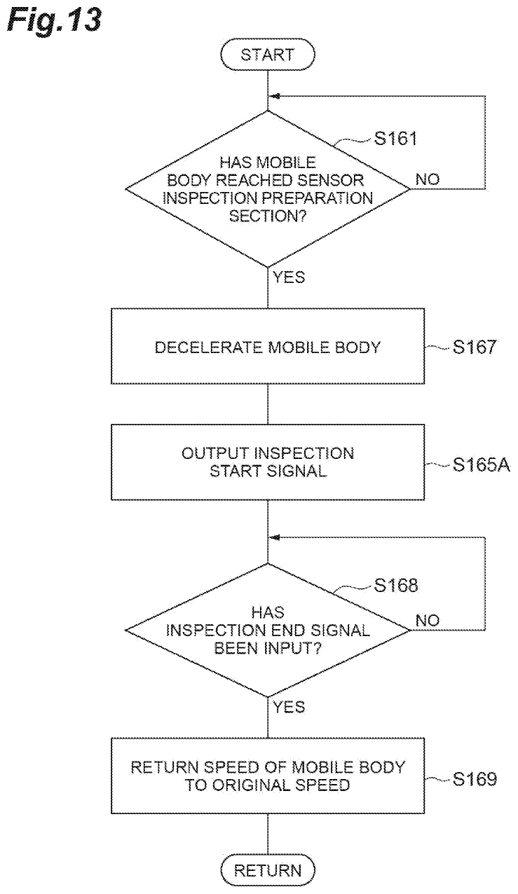

FIG. 13 is a flowchart illustrating a procedure of the inspection preparation process performed by the inspection preparation processing unit 26A and corresponds to FIG. 9. In FIG. 13, the inspection preparation processing unit 26A, first, determines whether the mobile body 1 has reached a sensor inspection preparation section S0 (procedure S161).

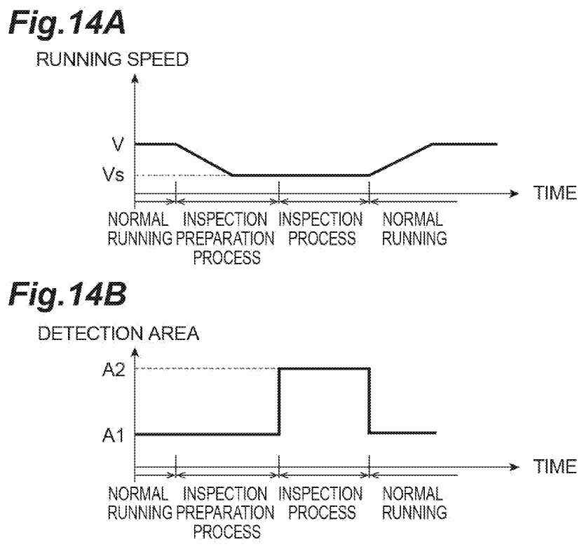

When it is determined that the mobile body 1 has reached the sensor inspection preparation section S0, the inspection preparation processing unit 26A performs control of the drive unit 13 such that it decelerates the mobile body 1 to a speed Vs (see FIGS. 14A and 14B) causing the mobile body 1 not to come into contact with the obstacle X at the time of the mobile body 1 running in the sensor inspection section S (procedure S167).

For example, the inspection preparation processing unit 26A performs control of the drive unit 13 such that it decelerates the mobile body 1 to a speed at which the inspection process for the obstacle sensor using the inspection processing unit 24 can be ended in a first area A1 in which it is detected by the obstacle sensor 5 that no obstacle X is currently present in the traveling direction of the mobile body 1. More specifically, when a time required for an inspection of the obstacle sensor is denoted by t, the inspection preparation processing unit 26A performs control of the drive unit 13 such that a running speed of the mobile body 1 after deceleration is equal to or lower than (L1/t). As described above, L1 is a length dimension of the first area A1 (see FIG. 1).

Subsequently, the inspection preparation processing unit 26A outputs an inspection start signal to the running control unit 22, the inspection processing unit 24, and the detection area setting unit 25A (procedure S165A).

Subsequently, the inspection preparation processing unit 26A determines whether an inspection end signal has been input from the inspection processing unit 24 (procedure S168). When it is determined that the inspection end signal has been input, the inspection preparation processing unit 26A performs control of the drive unit such that the running speed of the mobile body 1 is returned to the original speed V (procedure S169) and performs the procedure S161 described above again.

When the running speed of the mobile body 1 is changed, for example, the inspection preparation processing unit 26A may perform feedback control of the running speed of the mobile body 1 using a vehicle speed sensor.

As above, at the time of normal running of the mobile body 1, after the mobile body 1 reaches the sensor inspection preparation section S0, as illustrated in FIGS. 14A and 14B, the mobile body 1 is decelerated to a speed Vs for not coming into contact with an obstacle X present in the vicinity thereof even when running for a time required for an inspection of the obstacle sensor 5.

After the mobile body 1 runs for a time required for an inspection of the obstacle sensor 5, when the mobile body 1 reaches the sensor inspection section S, as illustrated in FIGS. 14A and 14B, the detection area A of the obstacle sensor 5 is set to the second area A2 that is wider than the first area A1 of the time of normal running, and the mobile body 1 travels at the same speed Vs. In that state, an inspection of the obstacle sensor 5 is performed.

When the still object for inspection 4C is detected by the obstacle sensor 5, it is determined that the obstacle sensor 5 is normal. Then, the detection area A of the obstacle sensor 5 is changed from the second area A2 to the first area A1, and the mobile body 1 returns to the normal running state.

On the other hand, when the still object for inspection 4C is detected by the obstacle sensor 5, it is determined that the obstacle sensor is abnormal. Then, together with giving a warning using the alarm unit 14, the mobile body 1 is forcedly stopped.

As above, in this embodiment, when the mobile body 1 reaches the sensor inspection preparation section S0, the mobile body 1 decelerates to a speed Vs causing not being contact with an obstacle at the time of running in the sensor inspection section S. In this way, by decelerating the mobile body 1 in the sensor inspection preparation section S0, a distance required for inspecting the obstacle sensor 5 can be shortened.

In addition, in this embodiment, although the detection area A of the obstacle sensor 5 at the time of the mobile body 1 running in the sensor inspection preparation section S0 is set to the first area A1 that is the same as that at the time of normal running, the present disclosure is not particularly limited to such a form, and, for example, the detection area may be narrower than the first area A1.

As above, while several embodiments of the present disclosure have been described, the present disclosure is not limited to the embodiments described above. For example, in the embodiment described above, although the detection area A of the obstacle sensor 5 at the time of the mobile body 1 running in the sensor inspection section S is set to the second area A2 that is wider than the first area A1 in the traveling direction of the mobile body 1, the present disclosure is not particularly limited to such a form.

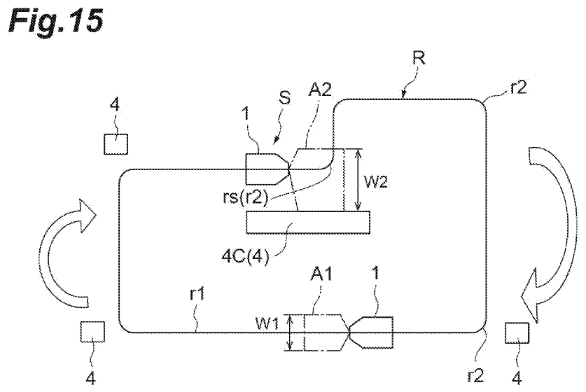

For example, as illustrated in FIG. 15, the detection area A of the obstacle sensor 5 at the time of the mobile body 1 running in the sensor inspection section S may be set to a second area A2 that is wider than the first area A1 in a width direction of the mobile body 1. The width direction of the mobile body 1 is a direction that is perpendicular to the traveling direction of the mobile body 1. A width dimension W2 of the second area A2 is larger than a width dimension W1 of the first area A1. A width dimension is a dimension along a width direction of the mobile body 1. In this case, the second area A2 is determined in accordance with a width dimension of the mobile body 1 or a width dimension of a trolley towed by the mobile body 1. In addition, for example, as the still object for inspection 4C, a still object 4 such as a shelf or a wall extending in the traveling direction of the mobile body 1 is designated.

Furthermore, the detection area A of the obstacle sensor 5 at the time of the mobile body 1 running in the sensor inspection section S may be set to a second area A2 that is wider than the first area A1 in the traveling direction and the width direction of the mobile body 1. In this case, a still object 4 present in the traveling direction or a lateral side of the mobile body 1 at the time of the mobile body 1 running along a running path R is used as the still object for inspection 4C. Thus, options of the still object 4 used as the still object for inspection 4C can be increased.

In addition, in the first embodiment described above, also the detection area A of the obstacle sensor 5 at the time of the mobile body 1 running in the sensor inspection preparation section S0 may be set to a second area A2 that is wider than the first area A1 in the width direction of the mobile body 1 or may be set to a second area A2 that is wider than the first area A1 in the traveling direction and the width direction of the mobile body 1.

Furthermore, in the embodiment described above, although the sensor inspection section S is designated to be at a position on a side in front of the curved part rs of the running path R in the traveling direction of the mobile body 1, the present disclosure is not particularly limited to such a form, and it may be designated to be at a position in the linear part r1 that is separate away from the curved part r2 as long as the obstacle sensor 5 can be inspected.

In addition, in the embodiment described above, in the sensor inspection preparation section S0 positioned on a side in front of the sensor inspection section S in the traveling direction of the mobile body 1, although preparation for causing the mobile body 1 not to come into contact with the obstacle X at the time of the mobile body 1 running in the sensor inspection section S is performed, the present disclosure is not particularly limited to such a form. For example, in a case in which no obstacle X is present in the sensor inspection section S, the preparation for causing the mobile body 1 not to come into contact with the obstacle X at the time of the mobile body 1 running in the sensor inspection section S may not be performed.

Furthermore, in the embodiment described above, although the obstacle sensor 5 is a laser sensor, the present disclosure is not particularly limited to such a form, and a camera or the like may be used as the obstacle sensor 5.

In addition, in the embodiment described above, although a self-position of the mobile body 1 is estimated using the SLAM technique using detection data acquired by a laser sensor as the self-position estimation sensor 12, the present disclosure is not particularly limited to such a form. As a technique for estimating the self-position of the mobile body 1, for example, a magnetic sensor detecting a magnetic tape disposed in the running path R, a SLAM technique using image data acquired by a camera, an odometry sensor detecting an amount of movement and a movement direction of the mobile body 1, an inertial measurement unit (IMU) measuring an angular velocity and an acceleration of a mobile body 1, or the like may be used.

Furthermore, in the embodiment described above, although the inspection process for the obstacle sensor 5 is performed every time the mobile body 1 passes through the sensor inspection section S designated in the running path R of a circulation course, the present disclosure is not particularly limited to such a form, and the inspection process for the obstacle sensor 5 may be performed only once per several cycles. The running path R is not particularly limited to a circulation course.

In addition, although the embodiment described above is a device and a method for performing an inspection of an obstacle sensor 5 detecting an obstacle X present in the vicinity of a mobile body 1 that is an industrial vehicle, the present disclosure can be applied also to a mobile body other than an industrial vehicle.

1. An obstacle sensor inspection device that performs an inspection of an obstacle sensor detecting an obstacle present in the vicinity of a mobile body, the obstacle sensor inspection device comprising:
a running control unit configured to perform control such that the mobile body is caused to run along a running path;
an inspection processing unit configured to perform an inspection process for the obstacle sensor using a still object for inspection that is designated in advance in a sensor inspection section designated in advance in a state in which the mobile body is running along the running path; and
a detection area setting unit configured to set a detection area of the obstacle sensor to a second area larger than a first area that is used at the time of normal running when the inspection process for the obstacle sensor is performed using the inspection processing unit,
wherein the inspection processing unit determines that the obstacle sensor is normal when the still object for inspection is detected by the obstacle sensor and determines that the obstacle sensor is abnormal when the still object for inspection is not detected by the obstacle sensor.
   2. The obstacle sensor inspection device according to embodiment 1, further comprising an inspection preparation processing unit configured to perform a preparation process for causing the mobile body not to come into contact with the obstacle when the mobile body runs in the sensor inspection section, in a sensor inspection preparation section positioned on a side in front of the sensor inspection section in a traveling direction of the mobile body before the inspection process for the obstacle sensor is performed by the inspection processing unit.
   3. The obstacle sensor inspection device according to embodiment 2,
wherein the inspection preparation processing unit sets the detection area of the obstacle sensor to a third area larger than the first area and determines whether or not the obstacle is detected by the obstacle sensor in the state as the preparation process, and
wherein, in a case in which it is determined by the inspection preparation processing unit that the obstacle is not detected by the obstacle sensor, the inspection processing unit determines that the obstacle sensor is normal when the still object for inspection is detected by the obstacle sensor and determines that the obstacle sensor is abnormal when the still object for inspection is not detected by the obstacle sensor.
   4. The obstacle sensor inspection device according to embodiment 2, wherein the inspection preparation processing unit performs control of the mobile body to be decelerated to a speed for not coming into contact with the obstacle at the time of the mobile body running in the sensor inspection section as the preparation process.
   5. The obstacle sensor inspection device according to any one of embodiments 1 to 4, wherein the second area is set to be wider than the first area in at least one of a traveling direction and a width direction of the mobile body.
   6. The obstacle sensor inspection device according to any one of embodiments 1 to 5,
wherein the running path includes a curved part,
wherein the sensor inspection section is designated to be at a position on a side in front of the curved part in a traveling direction of the mobile body, and
wherein the still object for inspection is disposed at a position entering the inside of the second area when the mobile body runs in the sensor inspection section.
   7. An obstacle sensor inspection method for performing an inspection of an obstacle sensor detecting an obstacle present in the vicinity of a mobile body, the obstacle sensor inspection method comprising:
designating a sensor inspection section in which an inspection of the obstacle sensor is performed, a sensor inspection preparation section positioned on a side in front of the sensor inspection section in a traveling direction of the mobile body, and a still object for inspection used for an inspection of the obstacle sensor in the sensor inspection section, in the middle of a running path in which the mobile body runs;
performing control such that the mobile body is caused to run along the running path;
performing an inspection process for the obstacle sensor using the still object for inspection in a state in which the mobile body is running along the running path in the sensor inspection section; and
setting a detection area of the obstacle sensor to a second area larger than a first area that is used at the time of normal running when the inspection process for the obstacle sensor is performed,
wherein, in the performing of an inspection process for the obstacle sensor, it is determined that the obstacle sensor is normal when the still object for inspection is detected by the obstacle sensor, and it is determined that the obstacle sensor is abnormal when the still object for inspection is not detected by the obstacle sensor.

### REFERENCE SIGNS LIST

1 Mobile body
4C Still object for inspection
5 Obstacle sensor
20, 20A Obstacle sensor inspection device
22 Running control unit
24 Inspection processing unit
25, 25A Detection area setting unit
26, 26A Inspection preparation processing unit
A Detection area
A1 First area
A2 Second area
A3 Third area
R Running path
rs Curved part
S Sensor inspection section
S0 Sensor inspection preparation section
X Obstacle

What is claimed is:

1. An obstacle sensor inspection device that performs an inspection of an obstacle sensor detecting an obstacle present in the vicinity of a mobile body, the obstacle sensor inspection device comprising:
a running control unit configured to perform control such that the mobile body is caused to run along a running path;
an inspection processing unit configured to perform an inspection process for the obstacle sensor using a still object for inspection that is designated in advance in a sensor inspection section designated in advance in a state in which the mobile body is running along the running path; and
a detection area setting unit configured to set a detection area of the obstacle sensor to a second area larger than a first area that is used at the time of normal running when the inspection process for the obstacle sensor is performed using the inspection processing unit,
wherein the inspection processing unit determines that the obstacle sensor is normal when the still object for inspection is detected by the obstacle sensor and determines that the obstacle sensor is abnormal when the still object for inspection is not detected by the obstacle sensor.

2. The obstacle sensor inspection device according to claim 1, further comprising an inspection preparation processing unit configured to perform a preparation process for causing the mobile body not to come into contact with the obstacle when the mobile body runs in the sensor inspection section, in a sensor inspection preparation section positioned on a side in front of the sensor inspection section in a traveling direction of the mobile body before the inspection process for the obstacle sensor is performed by the inspection processing unit.

3. The obstacle sensor inspection device according to claim 2,
wherein the inspection preparation processing unit sets the detection area of the obstacle sensor to a third area larger than the first area and determines whether or not the obstacle is detected by the obstacle sensor in the state as the preparation process, and
wherein, in a case in which it is determined by the inspection preparation processing unit that the obstacle is not detected by the obstacle sensor, the inspection processing unit determines that the obstacle sensor is normal when the still object for inspection is detected by the obstacle sensor and determines that the obstacle sensor is abnormal when the still object for inspection is not detected by the obstacle sensor.

4. The obstacle sensor inspection device according to claim 2, wherein the inspection preparation processing unit performs control of the mobile body to be decelerated to a speed for not coming into contact with the obstacle at the time of the mobile body running in the sensor inspection section as the preparation process.

5. The obstacle sensor inspection device according to claim 1, wherein the second area is set to be wider than the first area in at least one of a traveling direction and a width direction of the mobile body.

6. The obstacle sensor inspection device according to claim 1,
wherein the running path includes a curved part,
wherein the sensor inspection section is designated to be at a position on a side in front of the curved part in a traveling direction of the mobile body, and
wherein the still object for inspection is disposed at a position entering the inside of the second area when the mobile body runs in the sensor inspection section.

7. An obstacle sensor inspection method for performing an inspection of an obstacle sensor detecting an obstacle present in the vicinity of a mobile body, the obstacle sensor inspection method comprising:
designating a sensor inspection section in which an inspection of the obstacle sensor is performed, a sensor inspection preparation section positioned on a side in front of the sensor inspection section in a traveling direction of the mobile body, and a still object for inspection used for an inspection of the obstacle sensor in the sensor inspection section, in the middle of a running path in which the mobile body runs;
performing control such that the mobile body is caused to run along the running path;
performing an inspection process for the obstacle sensor using the still object for inspection in a state in which the mobile body is running along the running path in the sensor inspection section; and
setting a detection area of the obstacle sensor to a second area larger than a first area that is used at the time of normal running when the inspection process for the obstacle sensor is performed,
wherein, in the performing of an inspection process for the obstacle sensor, it is determined that the obstacle sensor is normal when the still object for inspection is detected by the obstacle sensor, and it is determined that the obstacle sensor is abnormal when the still object for inspection is not detected by the obstacle sensor.
